(19) United States
(12) Patent Application Publication
(10) Pub. No.: US 2026/0275706 A1
(43) Pub. Date: Sep. 17, 2026

(54) BRACKET FOR MODULAR OUTDOOR STRUCTURE AND METHOD OF FORMING BRACKET FOR MODULAR OUTDOOR STRUCTURE

(71) Applicant: Wilbert Williams, West Bloomfield, MI (US)

(72) Inventor: Wilbert Williams, West Bloomfield, MI (US)

(21) Appl. No.: 19/469,730

(22) PCT Filed: Mar. 26, 2024
(86) PCT No.: PCT/US2024/021501

§ 371 Date: Sep. 26, 2025

Related U.S. Application Data
(60) Provisional application No. 63/492,390, filed on Mar. 27, 2023.

(51) Int. Cl. E04B 1/26; F16B 7/00

(52) U.S. Cl. CPC E04B 1/26; F16B 7/00

(57) ABSTRACT

A method for forming a bracket includes steps of receiving a tube and defining one or more apertures in peripheral walls of the tube. The steps also include defining a 90 degree notch in the peripheral walls at an intermediate portion of the tube between a first end and a second end of the tube. The steps further include folding the first end of the tube toward the second end of the tube at the 90 degree notch and coupling the peripheral walls of the tube at the intermediate portion.

### CROSS REFERENCE TO RELATED APPLICATIONS

This application claims priority under 35 U.S.C. § 119(e) to U.S. Provisional Application 63/492,390, filed on Mar. 27, 2023. The disclosures of this prior application is considered part of the disclosure of this application and is hereby incorporated by reference in its entirety.

### FIELD

The present invention relates to a bracket, and more particularly, to a method of forming a bracket for a pergola.

### BACKGROUND

This section provides background information related to the present disclosure and is not necessarily prior art.

Portable outdoor structures, such as gazebos and pergolas, are typically provided as in outdoor gathering spaces. These structures may be provided as modular assemblies, whereby a builder or user can selectively couple various structural elements together in a desired configuration to accommodate an outdoor space. While structural elements of these outdoor structures may be directly connected to each other using integrated joints within the structural members, such features inhibit customization or may be difficult to implement by an end user. Further, structural elements may be directly attached to each other by fasteners, such as screws or bolts, but such assembly requires additional measurement and layout of the structural elements.

Thus, while known systems for assembling outdoor structures are suitable, there remains a need in the art for brackets that can be efficiently manufactured and that allow modular assembly of standard structural elements (e.g., standard wooden beams or planks). Further, there exists a need in the art for methods of forming such brackets that minimizes manufacturing costs and improves quality.

### SUMMARY

An aspect of the disclosure provides a bracket for securing one or more structural members of a pergola assembly. The bracket includes a first tube section including a plurality of first peripheral walls defining a first socket for receiving a first structural member, and a second tube section including a plurality of second peripheral walls defining a second socket for receiving a second structural member, a first one of the second peripheral walls integrally formed with a first one of the first peripheral walls along a joint connecting the first tube section and the second tube section.

Implementations of the disclosure may include one or more of the following optional features. In some examples, at least one of plurality of the first peripheral walls includes one or more apertures formed therethrough. In some examples, the first tube section extends from a first end defining a first receptacle to a second end defining a first joint portion and the second tube section extends from a third end defining a second receptacle to a fourth end defining a second joint portion that is attached to the first joint portion. Optionally, the plurality of first peripheral walls includes a first bottom wall, a first top wall, and a pair of first sidewalls extending between the first bottom wall and the first top wall to define a rectangular first socket.

In some examples, the plurality of second peripheral walls includes a second bottom wall, a second top wall, and a pair of second sidewalls extending between the second bottom wall and the second top wall to define a rectangular second socket. In some implementations, the first bottom wall and the second bottom wall are integrally formed. Optionally, the first bottom wall and the second bottom wall are integrally formed and connected by a bend. In some configurations, the second end of the first tube section is welded to the fourth end of the second tube section along at least one of the pair of the first sidewalls or the first top wall.

Another aspect of the disclosure provides a method for forming a bracket. The method includes receiving a straight tube having one or more peripheral walls. The method further includes forming a ninety-degree notch in the peripheral walls at an intermediate portion of the straight tube between a first end and a second end of the straight tube the notch separating the straight tube into a first tube section and a second tube section joined together along a joint. The method further includes bending the first tube section of the straight tube toward the second tube section of the tube along the joint at the ninety-degree notch to form a bent tube. The method further includes coupling the peripheral walls of the first tube section and the second tube section along the notch.

Implementations of the disclosure may include one or more of the following optional features. In some examples, coupling the peripheral walls of the tube includes welding a first side of the ninety-degree notch to a second side of the ninety-degree notch. In some implementations, coupling the peripheral walls includes coupling a first side of the ninety-degree notch to a second side of the ninety-degree notch. In some examples, the straight tube includes four peripheral walls including a bottom wall, a top wall, and a pair of sidewalls extending between the bottom wall and the top wall. In some configurations, forming the notch includes cutting the notch through the top wall and each of the sidewalls while maintaining the bottom wall intact. In some implementations, bending the first tube section includes bending the first tube section toward the second tube section along the bottom wall to form a bend joint between the first tube section and the second tube section.

In some examples, the method further includes the step of forming one or more apertures in the peripheral walls of the straight tube before bending the first tube section toward the second tube section. Optionally, the notch and the one or more apertures are formed in the tube using a multi-axis cutting system. In some implementations, the multi-axis cutting system includes a waterjet or laser cutting tool.

### DRAWINGS

The drawings described herein are for illustrative purposes only of selected configurations and not all possible implementations, and are not intended to limit the scope of the present disclosure.

FIG. 1A is a first perspective view of a bracket according to the principles of the present disclosure, where the bracket is in a first manufacturing state;

FIG. 1B is a second perspective view of a bracket according to the principles of the present disclosure, where the bracket is in a first manufacturing state;

FIG. 1C is a bottom view of the bracket of FIG. 1A;

FIG. 1D is a side elevation view of the bracket of FIG. 1A;

FIG. 1E is a top plan view of the bracket of FIG. 1A;

FIG. 1F is an end view of the bracket of FIG. 1A;

FIG. 1G is a side elevation view of the bracket of FIG. 1A;

FIG. 1H is a side elevation view of the bracket of FIG. 1A, showing the bracket in a second manufacturing state;

FIG. 1I is a side elevation view of the bracket of FIG. 1A, showing the bracket in a third manufacturing state;

FIG. 2A is a side elevation view of the bracket of FIG. 1A, showing the bracket in a fully formed state.

FIG. 2B is an end view of the bracket of FIG. 2A;

FIG. 2C is a perspective view of the bracket of FIG. 2A;

FIG. 3A is a front elevation view of another example of a bracket according to the principles of the present disclosure;

FIG. 3B is a bottom plan view of the bracket of FIG. 3A;

FIG. 3C is an end view of the bracket of FIG. 3A;

FIG. 3D is a perspective view of the bracket of FIG. 3A;

FIG. 4A is a perspective view of another example of a bracket according to the principles of the present disclosure;

FIG. 4B is an end view of the bracket of FIG. 4A;

FIG. 4C is a front side elevation view of the bracket of FIG. 4A;

FIG. 5A is a perspective view of another example of a bracket according to the principles of the present disclosure;

FIG. 5B is a rear elevation view of the bracket of FIG. 5A;

FIG. 5C is a front elevation view of the bracket of FIG. 5A;

FIG. 5D is an end view of the bracket of FIG. 5A;

FIG. 6A is a perspective view of another example of a bracket according to the principles of the present disclosure;

FIG. 6B is a rear elevation view of the bracket of FIG. 6A;

FIG. 6C is a front elevation view of the bracket of FIG. 6A;

FIG. 6D is an end view of the bracket of FIG. 6A; and

FIG. 7 is an exemplary flow diagram for forming an example bracket according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

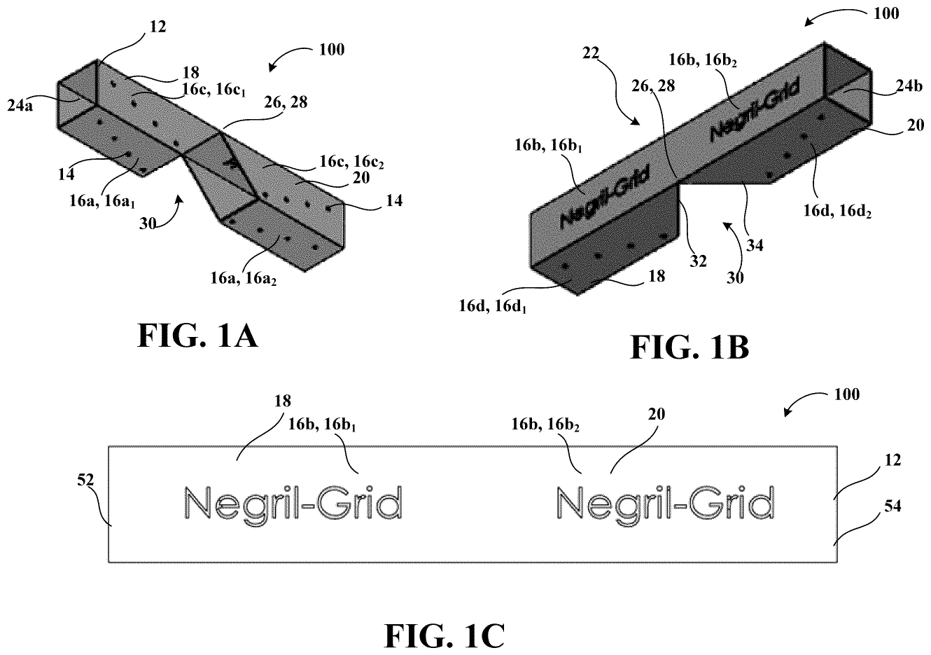

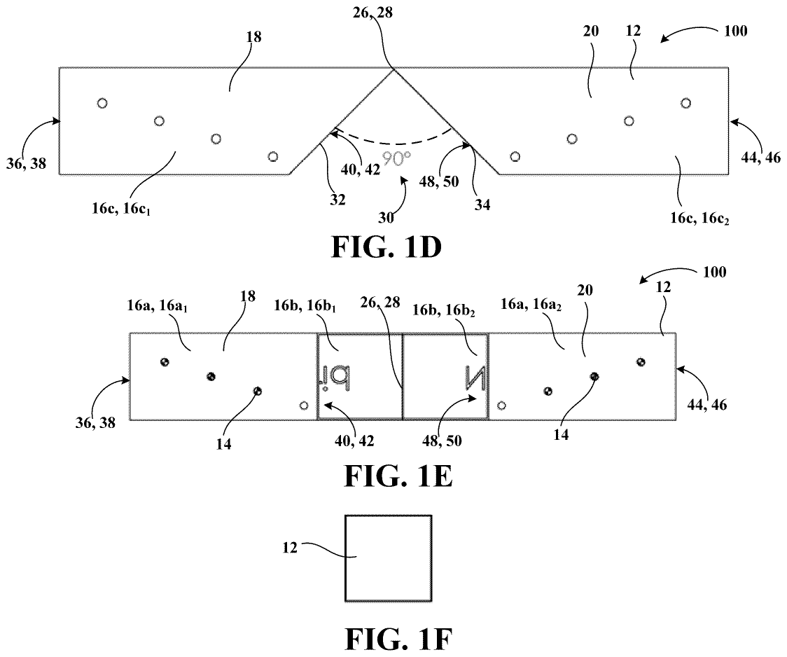

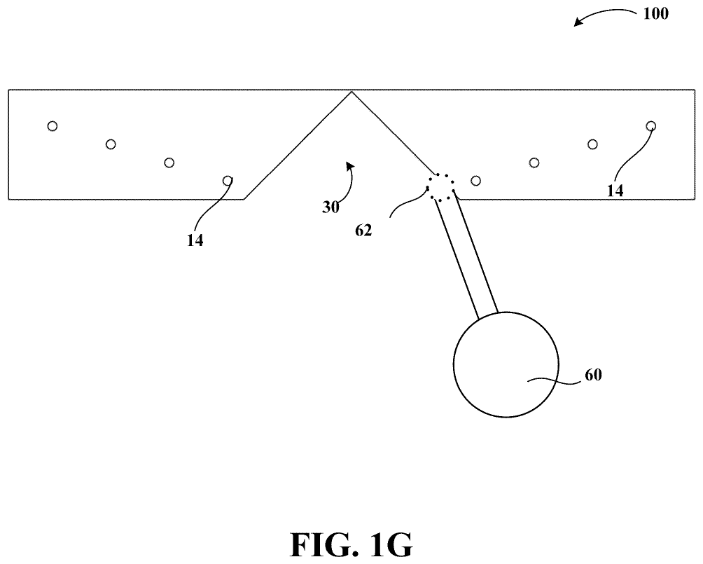

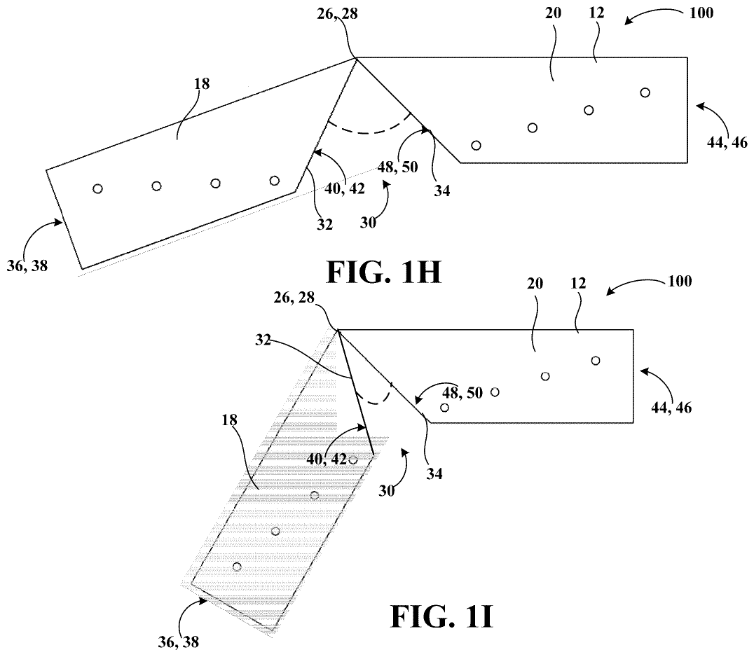

Referring to FIGS. 1A-1I, a bracket 100 for one or more structural members for a pergola assembly includes a tube 12 having one or more apertures 14 defined along peripheral walls 16a-16d of the tube 12. The apertures 14 may be defined on a single sidewall 16 or may alternatively be defined on one or more peripheral walls 16 of the tube 12. The tube 12 is provided as a square tube having four peripheral walls, including a top wall 16a, a bottom wall 16b, and a pair of side walls 16c, 16d. As illustrated in FIG. 1C, the peripheral walls 16a-16d of the tube 12 may include text or other indicia defined along the peripheral walls 16a-16d where the peripheral walls 16a-16d are free from the apertures 14. Additionally or alternatively, the peripheral walls 16 may include both the apertures 14 and the indicia.

Initially, the tube 12 is provided in a stock state including the four peripheral walls 16a-16d defining a solid and continuous tube. In other words, the tube stock 12 is initially provided as a segment of tube stock having the desired height and width. The tube segments may be cut to length in one or more pre-processing steps to provide an initial length of the tube 12. The tube stock 12 may be processed at one or more material removal steps (e.g., cutting) to form the tube into a first tube section 18 and a second tube section 20 with an intermediate portion 22 therebetween. The first tube section 18 includes a plurality of first peripheral walls 16a₁-16d₁ defining a first socket 24a for receiving a first structural member, and the second tube section 20 includes a plurality of second peripheral walls 16a₂-16d₂ defining a second socket 24b for receiving a second structural member. In some instances, at least one of the plurality of first peripheral walls 16a₁-16d₁ includes the one or more apertures 14 formed therethrough. The plurality of first peripheral walls 16a₁-16d₁ may include a first top wall 16a₁, a first bottom wall 16b₁, and a pair of first sidewalls 16c₁, 16d₁ extending between the first bottom wall 16b₁ and the first top wall 16a₁ to define the rectangular first socket 24a. Similarly, the plurality of second peripheral walls 16a₂-16d₂ may include a second top wall 16a₂, a second bottom wall 16b₂, and a pair of second sidewalls 16c₂, 16d₂ extending between the second bottom wall 16b₂ and the second top wall 16a₂ to define the rectangular second socket 24b. In some examples, the first bottom wall 16b₁ and the second bottom wall 16b₂ may be integrally formed.

For example, the first bottom 16b₁ and the second bottom wall 16b₂ may be integrally formed and connected by a bend 26. In some instances, a first one of the second peripheral walls 16a₂-16d₂ may be integrally formed with a first one of the first peripheral walls 16a₁-16d₁ along a joint 28 connecting the first tube section 18 and the second tube section 20. Here, a notch 30 is formed at the intermediate portion as approximately a 90 degree cutout in each of the side walls 16c, 16d of the tube 12. The notch 30 extends along the entirety of each side wall 16c, 16d from the bottom wall 16b and through the top wall 16a. Here, the notch 30 has a first side 32 and a second side 34 generally corresponding with the first tube section 18 and the second tube section 20 of the tube 12, respectively. The notch 30 may be formed by a multi-axis cutting system 60 (FIG. 1G). The multi-axis cutting system 60 may form the notch 30 via a plasma cutter, CNC mill, water jet, laser cutter or other conventional cutting system 62. Further, the multi-axis cutting system 60 may be utilized to form the one or more apertures 14.

It is generally contemplated that the tube 12 may be hollow, such that the notch 30 and the tube 12 may respectively be open at the first and second sides 32, 34 and the first and second tube sections 18, 20. For example, the first tube section 18 may extend from a first end 36 defining a first receptacle 38 to a second end 40 defining a first joint portion 42 corresponding to the first side 32 of the notch 30, and the second tube section extends from a third end 44 defining a second receptacle 46 to a fourth end 48 defining a second joint portion 50 that is attached to the first joint portion 42 and corresponds to the second side 34 of the notch 30.

FIG. 1A illustrates the tube 12 in an unfolded, linear configuration with the notch 30 defined at the intermediate portion 22. The bracket 100 is manufactured from the tube 12 by folding the intermediate section 22 along the bottom wall to bias first tube section 18 of the tube 12 toward the second tube section 20, thereby defining the joint 28 between the first tube section 18 and the second tube section 20. For example, as illustrated in FIGS. 1H and 1I, the folding of the tube 12 along the bend 26 closes the notch 30, such that the first side 32 of the notch 30 abuts the second side 34 to form the joint 28. The first side 32 of the notch 30 is coupled to the second side 34 via any practicable method of joining the first and second sides 32, 34 of the notch 30. By way of example, not limitation, the first and second sides 32, 34 are welded to one another. Stated differently, the peripheral walls 16 of the tube 12 may be joined at the intermediate portion via a welding process. It is contemplated that the peripheral walls 16 at the first tube section 18 of the tube are folded or otherwise repositioned proximate to the peripheral walls 16 at the second tube section 20, such that the first tube section 18 of the tube 12 is generally orthogonal to the second tube section 20. For example, the second end 40 of the first tube section 18 may be welded to the fourth end 48 of the second tube section 20 along at least one of the first of first sidewalls 16c₁, 16d₁ or the first top wall 16a₁.

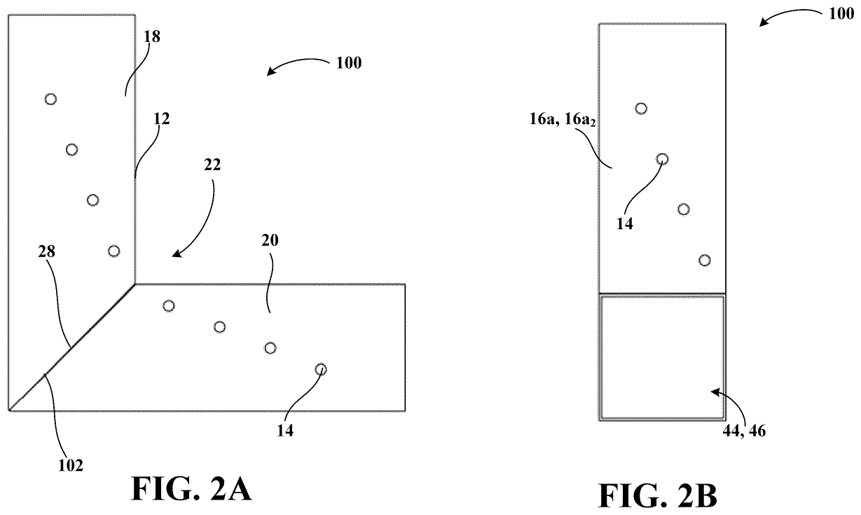

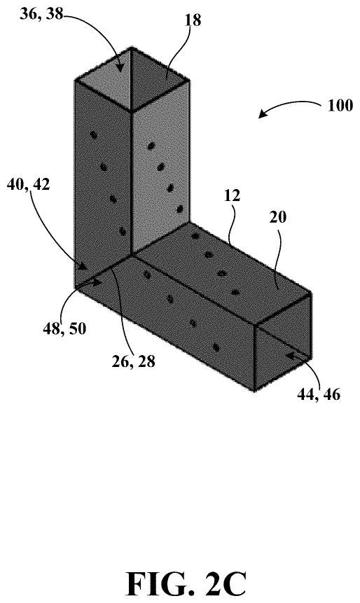

FIGS. 2A-2C illustrate the bracket 100 in the folded state. The bracket 100 includes a seam 102 at the joint of the intermediate portion 22 where the first tube section 18 of the tube is coupled to the second tube section 20. The bracket 100 may have an L-shaped configuration.

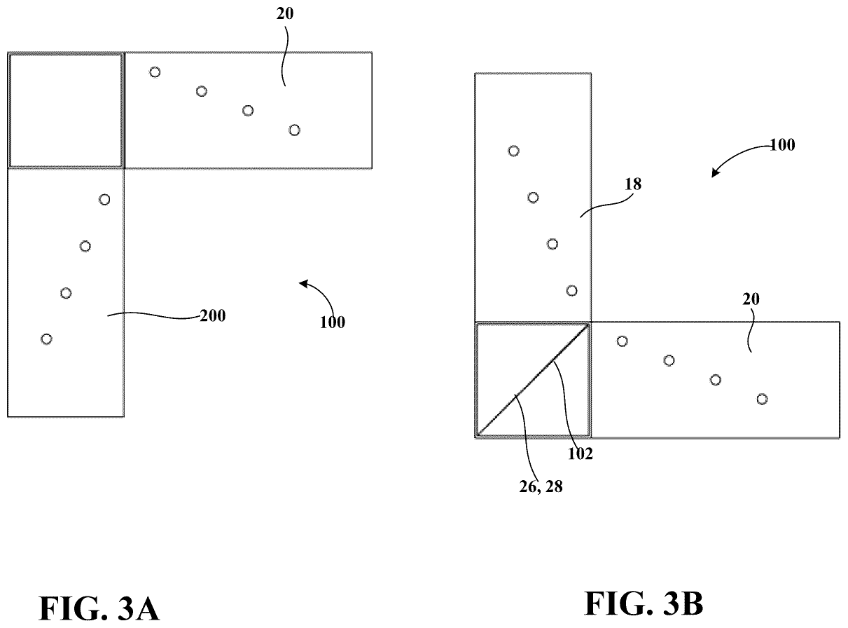

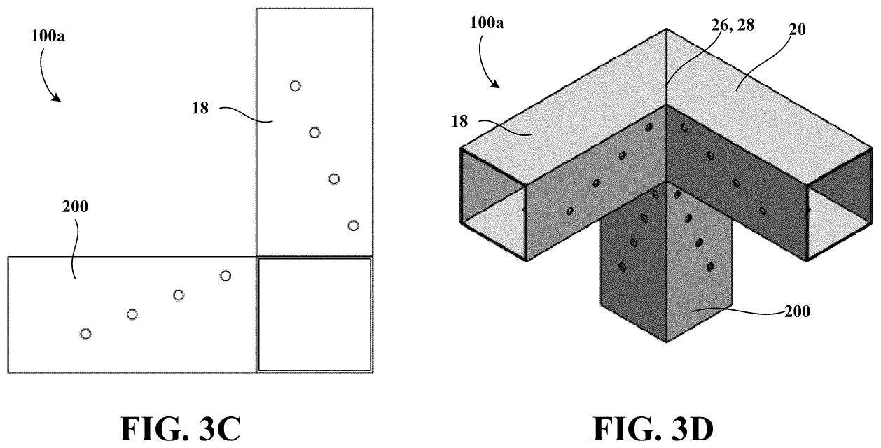

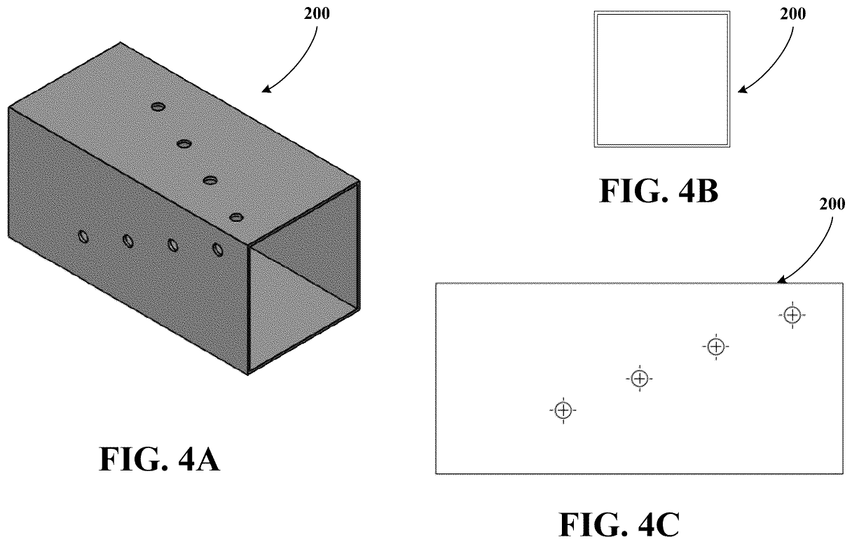

FIGS. 3A-4C illustrate another example of a bracket 100a according to the present disclosure. The bracket 100a of FIGS. 3A-4C includes the bracket 100 previously described in combination a tertiary tube section 200. As shown, the tube section 200 includes an additional straight segment of the tube stock used for forming the bracket 100. As shown in FIGS. 4A-4C, the tube section 200 may be cut to length and processed to include one or more of the apertures 14. Referring again to FIGS. 3A-3D, an end of the tube segment 200 is positioned such that outer walls of the tube segment are co-planar with the portion of the bottom wall 16b₁, 16b₂ forming the first and second tube sections 18, 20, whereby a longitudinal axis of the tube section 200 is perpendicular to and intersects longitudinal axes of each of the tube sections 18, 20 to provide a three-legged bracket 100a.

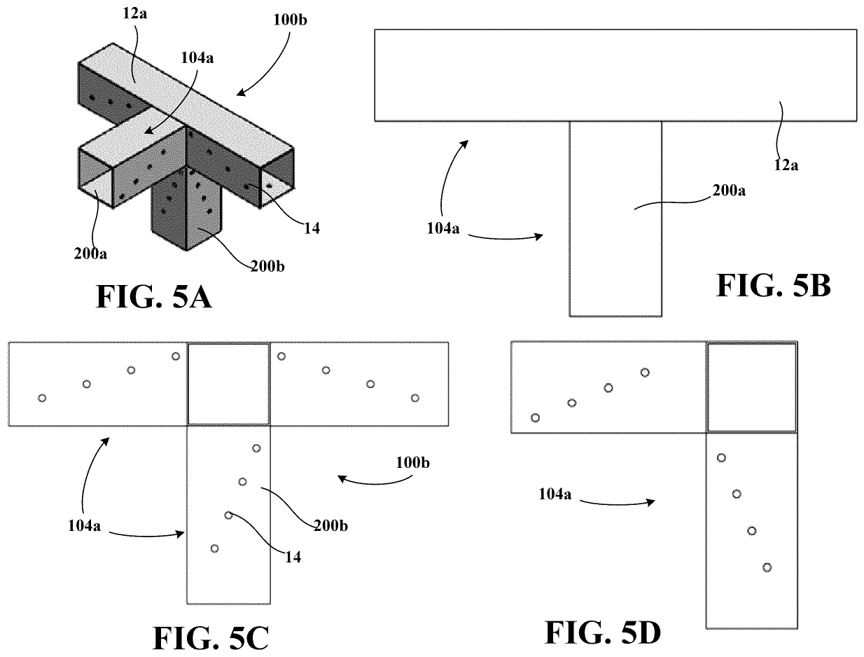

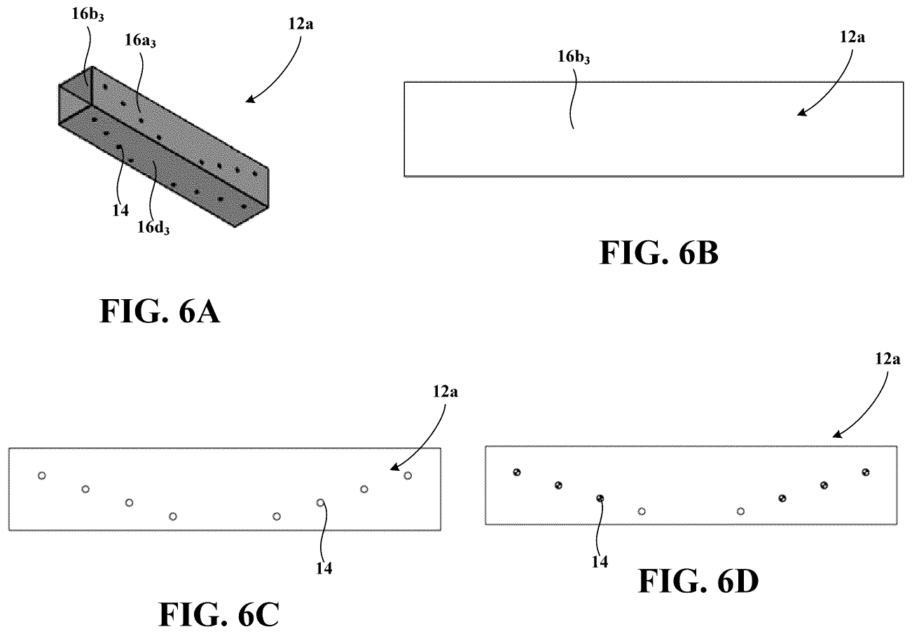

FIGS. 5A-6D illustrate another configuration of a bracket 100b. In view of the substantial similarity in structure and function of the components associated with the bracket 100, like reference numerals are used hereinafter and in the drawings to identify like components while like reference numerals containing letter extensions and/or subscripts are used to identify those components that have been modified. In this example, the bracket 100b includes four arms 104a each defining a respective socket. Two of the arms 104a are axially aligned at opposite ends from each other and may be formed by a linear tube 12a (FIGS. 6A-6D) that includes one or more apertures 14 defined along peripheral walls 16a₃-16d₃. A third arm 104a is defined by a secondary tube section 200a and a fourth arm 104a is defined by a tertiary tube section 200b. As shown, the secondary tertiary tube section 200a and the tertiary tube section 200b may be attached to adjacent peripheral walls 16a₃-16d₃ of the tube 12a at an intermediate portion 22a via welding or other practicable coupling methods. For example, at least one seam 102 may be formed at the attachment location between the tertiary tube sections 200a, 200b and the tube 12a during formation of the bracket 100a.

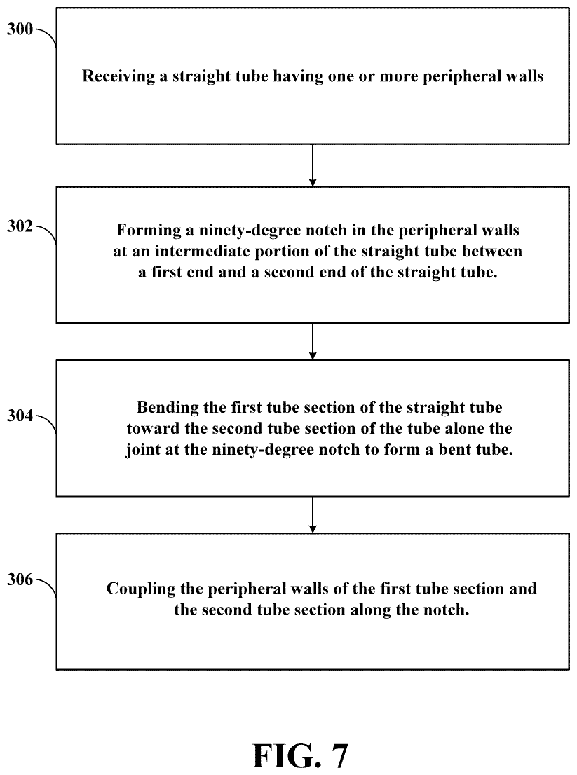

Referring now to FIG. 7, an exemplary method of forming the bracket 100, 100a is set forth. At 300, a straight tube 12 is received having one or more peripheral walls 16a-16d. A ninety-degree notch 30 is formed, at 302, in the peripheral walls 16a-16d at an intermediate portion 22 of the straight tube 12 between a first end 52 and a second end 54 of the straight tube 12 (FIG. 1C). For example, the notch 30 may be formed in the tube 12 using a multi-axis cutting system. The notch 30 separates the straight tube 12 into the first tube section 18 and the second tube section 20, which are joined together along the joint 28. The first tube section 18 of the straight tube 20, at 304, is bent toward the second tube section 20 along the joint 28 at the ninety-degree notch 30 to form a bent tube 12. At 306, the peripheral walls 16a-16d of the first tube section 18 and the second tube section 20 are coupled along the notch 30.

In some examples, coupling the peripheral walls 16a-16d of the tube 20 includes welding or otherwise coupling a first side 32 of the ninety-degree notch 30 to a second side 34 of the ninety-degree notch 30. In some instances, the notch 30 may be formed by cutting, via the multi-axis cutting system 60, the notch 30 through the top wall 16a and each of the side walls 16c, 16d of the straight tube 12 while maintaining the bottom wall 16b intact. The first tube section 18 may be bent toward the second tube section 20 along the bottom wall 16b to form a bend joint 28 between the first tube section 18 and the second tube section 20. As mentioned above, the peripheral walls 16a-16d may include the one or more apertures, which may be formed in the tube 12 using the multi-axis cutting system 60. In some examples, the cutting system 60 may include a waterjet or laser cutting tool.

A number of implementations have been described. Nevertheless, it will be understood that various modifications may be made without departing from the spirit and scope of the disclosure. Accordingly, other implementations are within the scope of the following claims.

The terminology used herein is for the purpose of describing particular example configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A bracket for securing one or more structural members of a pergola assembly, the bracket comprising:
a first tube section including a plurality of first peripheral walls defining a first socket for receiving a first structural member; and
a second tube section including a plurality of second peripheral walls defining a second socket for receiving a second structural member, a first one of the second peripheral walls integrally formed with a first one of the first peripheral walls along a joint connecting the first tube section and the second tube section.

2. The bracket of claim 1, wherein at least one of plurality of the first peripheral walls includes one or more apertures formed therethrough.

3. The bracket of claim 1, wherein the first tube section extends from a first end defining a first receptacle to a second end defining a first joint portion and the second tube section extends from a third end defining a second receptacle to a fourth end defining a second joint portion that is attached to the first joint portion.

4. The bracket of claim 3, wherein the plurality of first peripheral walls includes a first bottom wall, a first top wall, and a pair of first sidewalls extending between the first bottom wall and the first top wall to define a rectangular first socket.

5. The bracket of claim 4, wherein the plurality of second peripheral walls includes a second bottom wall, a second top wall, and a pair of second sidewalls extending between the second bottom wall and the second top wall to define a rectangular second socket.

6. The bracket of claim 5, wherein the first bottom wall and the second bottom wall are integrally formed.

7. The bracket of claim 6, wherein the first bottom wall and the second bottom wall are integrally formed and connected by a bend.

8. The bracket of claim 6, wherein the second end of the first tube section is welded to the fourth end of the second tube section along at least one of the pair of the first sidewalls or the first top wall.

9. A method for forming a bracket, the method comprising:
receiving a straight tube having one or more peripheral walls;
forming a ninety-degree notch in the peripheral walls at an intermediate portion of the straight tube between a first end and a second end of the straight tube the notch separating the straight tube into a first tube section and a second tube section joined together along a joint;
bending the first tube section of the straight tube toward the second tube section of the tube along the joint at the ninety-degree notch to form a bent tube; and
coupling the peripheral walls of the first tube section and the second tube section along the notch.

11. The method of claim 9, wherein coupling the peripheral walls of the tube includes welding a first side of the ninety-degree notch to a second side of the ninety-degree notch.

12. The method of claim 9, wherein coupling the peripheral walls includes coupling a first side of the ninety-degree notch to a second side of the ninety-degree notch.

13. The method of claim 9, wherein the straight tube includes four peripheral walls including a bottom wall, a top wall, and a pair of sidewalls extending between the bottom wall and the top wall.

14. The method of claim 13, wherein forming the notch includes cutting the notch through the top wall and each of the sidewalls while maintaining the bottom wall intact.

15. The method of claim 14, wherein bending the first tube section includes bending the first tube section toward the second tube section along the bottom wall to form a bend joint between the first tube section and the second tube section.

16. The method of any of claim 9, further comprising the step of forming one or more apertures in the peripheral walls of the straight tube before bending the first tube section toward the second tube section.

17. The method of claim 16, wherein the notch and the one or more apertures are formed in the tube using a multi-axis cutting system.

18. The method of claim 17, wherein the multi-axis cutting system includes a waterjet or laser cutting tool.
